(19) United States
(12) Patent Application Publication
(10) Pub. No.: US 2014/0255123 A1
(43) Pub. Date: Sep. 11, 2014

(54) THREADFORM LOCKING DEVICE AND METHODS

(71) Applicant: CANRIG DRILLING TECHNOLOGY LTD., Houston, TX (US)

(72) Inventor: Preston WEINTRAUB, Spring, TX (US)

(73) Assignee: Canrig Drilling Technology Ltd., Houston, TX (US)

(21) Appl. No.: 13/790,891

(22) Filed: Mar. 8, 2013

(51) Int. Cl. F16B 39/284; B23P 19/06

(52) U.S. Cl. CPC F16B 39/284; B23P 19/06
USPC 411/276; 29/525.11

(57) ABSTRACT

Locking devices and methods are described. The locking device includes a non-resilient locking threadform that is expandable and a threaded expander. The threadform includes a threaded exterior portion and an axially-oriented, threaded interior recess at a proximal end of the threadform. The threaded exterior portion has a length and is configured to connect two articles in an axial direction. The threaded expander has a threaded exterior that is oversized relative to the threaded interior recess so as to expand the threaded exterior portion radially as the threaded expander is positioned in the threaded interior recess.

### TECHNICAL FIELD

The present disclosure relates to the field of threaded connections, and more particularly to locking threaded connection devices and methods that prohibit or reduce loosening of connections due to vibration and/or heat.

### BACKGROUND OF THE DISCLOSURE

Loosening of threaded components is a common engineering problem. Conventional threaded fasteners are subject to vibrational loosening, thermal expansion, and/or breakage of screw threads. Vibrational loosening of fasteners creates reliability issues, unscheduled shutdown of equipment and additional costs.

Locking collars and other devices require access to the outer diameter and threading in the radial direction, which is inconvenient. Other products use axial screws that drive wedges into the shaft threads.

Oil rig operations have some of the harshest operational requirements of any industry. This is particularly true today as more remote, hard-to-reach, onshore and offshore oil reserves are sought, and the demand to drill deeper at higher speed continues. Despite ever more extreme shock, vibration and temperature, critical joints must be maintained and production downtime minimized.

Thus, a need exists for improved locking devices and methods that provide secure connections, particularly from an axial direction.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a perspective view of a locking device according to one or more aspects of the present disclosure.

FIG. 2 is a magnified view of the threaded interior recess according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The present disclosure provides a threadform locking device that is accessed in the axial direction and is expandable by deformation. Deformation of the locking device increases friction between the device and components threaded thereto, and can slightly change the pitch of the threadform. The locking device may be a separate collar, an integral part of a nut, screw, or bolt, or a specially designed threaded component.

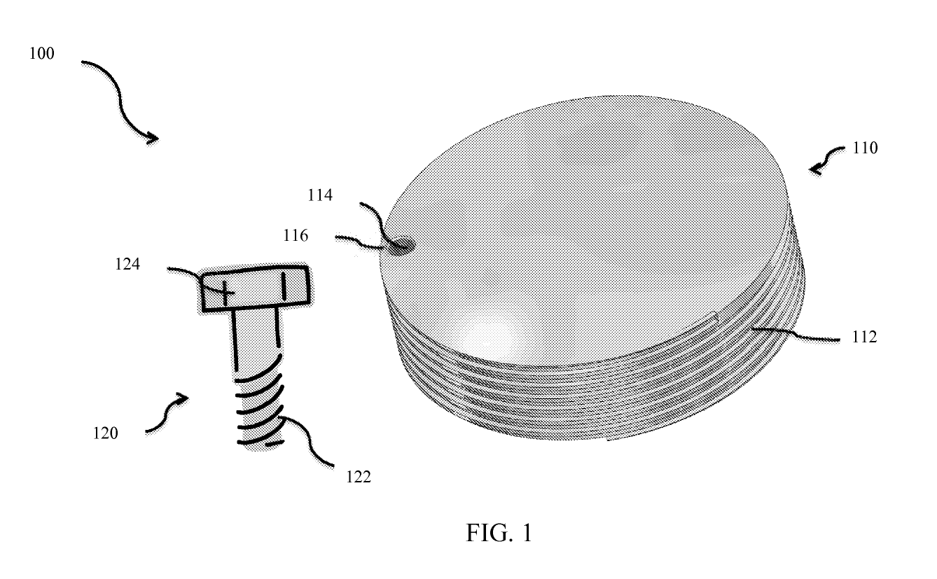

Referring to FIG. 1, the locking device 100 of the present disclosure includes: (1) a non-resilient locking threadform 110 having a threaded exterior portion 112 that is expandable in a radial direction and that is configured to connect and retain two adjacent external articles and (2) a threaded expander 120 having a threaded exterior 122. The radial expansion may occurs as a result of the slot 116, which can facilitate expansion at the circumference of the threadform 110, typically adjacent to the slot 116 when it is present. The threaded expander 120 is provided for affecting expansion of the expandable portion of the threadform 110. The threaded expander 120 is receivable in the axially-oriented, threaded interior recess 114 of the threadform 110.

In one embodiment, the non-resilient threadform 110 is predominantly metal. Any available metal may be selected. In various embodiments, the locking threadform 110 is metal, or a combination (including blends and alloys) thereof. An exemplary metal is steel, such as a stainless steel. Some particularly suitable stainless steels are those selected to minimize or eliminate corrosion of the threadform 110 when used in a given environment, and may still include minor amounts of other components non-metal or otherwise to provide such a desired effect. By “predominantly metal” is meant that more than 50 weight percent of the threadform 110 is metal, preferably at least about 75 weight percent is metal, and more preferably at least about 90 percent is metal. In another embodiment, the threadform 110 at least substantially is metal. By “substantially” is meant that at least about 90 weight percent of the threadform 110 is metal, preferably at least about 95 weight percent is metal, and more preferably at least about 98 weight percent is metal.

The threaded expander 120 may also be made of a hard material or other non-resilient material, such as an independently selected metal from those discussed herein, and may be in the general form of a screw, bolt, or stud. The material of the threadform 110 and the threaded expander 120 can be selected to achieve the desired degree of locking to resist torsional and vibrational forces exerted thereon.

The threadform 110 includes the threaded interior recess 114 at a proximal end of the threadform 110. The threaded interior recess 114 may be cylindrical or tapered, such as with a taper having a change in radius or diameter of about 0.001 to 0.1 inches per inch along the length, more preferably a change of about 0.005 to 0.5 inches per inch along the length. In an exemplary embodiment, the change is about 0.02 inches per inch along the length. When tapered, the interior recess 114 is wider at the proximal end of the threadform 110, and narrower at a distal location.

The interior recess 114 may be any suitable size to accommodate the threaded expander 120. In some embodiments, the interior recess 114 has a diameter that is about 1 to 10 percent of the diameter of the threadform 110, and in other embodiments, the interior recess 114 has a diameter that is about 50 to 85 percent of the diameter of the threadform 110.

The interior recess 114 is sized smaller than the maximum radius of the expander 120 in one embodiment. In another embodiment, the interior recess 114 includes threads that mismatched in size compared to the threads of the threaded expander 120. In this embodiment, for example, the internal threads of the interior recess 114 may be “undersized,” i.e., smaller in diameter or radius than the threads of the threaded expander 120. In another aspect of this embodiment, the internal threads of the interior recess 114 may be oversized, i.e., larger in diameter or radius than the outermost part of the threads of the threaded expander 120, such that the expander 120 pushes outwards on the internal threads as it is threaded distally into the interior recess 114. In one embodiment, the undersized threads of the interior recess 114 are located a distance from entry into the interior recess 114. In other words, the threads at the entry of the interior recess 114 may be normal sized, e.g., the same size as the threads of the threaded expander 120, and the threads that are undersized may be located distally from the entry of the interior recess 114.

The threaded expander 120 is thus oversized relative to the interior recess 114 (and the recess 114 is undersized relative to the expander 120) so as to expand the threaded exterior portion 112 radially from an unexpanded state to an expanded state as the threaded expander 120 is positioned in the interior recess 114. Thus, this arrangement will force the interior recess 114 and consequently the threadform 110 to expand (e.g., transition from the unexpanded to the expanded state) when the threaded expander 120 is moved into the interior recess 114. In some embodiments, the threaded expander 120 has a full thread thereon, extending from one end to another. In other embodiments, only a portion of the threaded expander 120 includes threads.

To ensure a sufficient fit between the threaded expander 120 and threadform 110 that is resistant to unthreading or release of the expander 120 after positioning it in the recess 114 so the threaded exterior portion 112 is in the expanded state, it is preferable that the inside diameter of the interior recess 114 is slightly smaller than the outer diameter of the threaded expander 120. In an embodiment, the threaded expander 120 is disposed within the interior recess 114 with the threaded expander 120 flush against the top surface of the threadform 110. In other embodiments, the entire length of the threaded expander 120 is inserted in the interior recess 114 with a mechanism to rotate the threaded expander 120 at the proximal end, or only a portion of the threaded expander 120 is positioned within the interior recess 114 so a portion protrudes from the interior recess 114.

The threaded expander 120 may have any suitable length to affect expansion of the threaded exterior portion 112 of the threadform 110, although typically it is not much longer than the recess 114 if at all. When the expander 120 is shorter in length than the recess 114 is deep, it may be inserted sufficiently so that it is flush or recessed from the proximal end of the threadform 110. In one embodiment, the threaded expander 120 has a length that is at least substantially the same as the length of the interior recess 114. By “substantially the same” is meant that the length is at least about 85 percent the length of the interior recess 114, preferably at least about 90 percent, and more preferably at least about 95 percent. In other embodiments, the threaded expander 120 has a length that is smaller or greater than the length of the interior recess 114.

The threadform 110, in its expanded state, provides a tight, frictional threaded engagement between the threaded exterior portion 112 and the threads of at least two adjacent external articles. In one embodiment, the two external articles each have an internal threaded portion that is opposed to and cooperates with the threaded exterior portion 112. In an alternative embodiment, more than two articles are joined together by the threadform 110, e.g., a third article in between the two articles that surrounds or entirely encircles the threadform 110 and is positioned between two other articles.

To use the locking device 100, the threadform 110 may be brought into threaded engagement with external articles, either concurrently or sequentially, in the desired position to be maintained. The threaded expander 120 can then be fully inserted into the interior recess 114 and tightened, e.g., by threading, and the threadform 110 thus expanded to affect a locking force between the external articles in association therewith to maintain them in place or minimize their unthreading due to operational forces such as vibration, material fatigue or temperature cycling, etc. In an alternative embodiment, the threaded expander 120 may be tied down, e.g., with wire, rather than screwed into the interior recess 114. The degree of radial deformation can be varied to achieve the desired locking effect. In an embodiment, the transition to the expanded state increases linearly with a distance of the threaded expander 120 into the interior recess 114. As the threaded expander 120 is positioned further within the interior recess 114, the threaded exterior portion 112 of the threadform 110 expands further. The threaded expander 120 may be removed from the interior recess 114 when it is desired to loosen the locking force to shift or detach any of the articles operably associated by the threadform 110.

In the embodiment shown, the threaded expander 120 includes a flat head 124. The head 124 typically includes one or more of a slit, slot, hole, opening, or any other threading feature or combination thereof at a proximal end thereof that enables the threaded expander 120 to be threaded, positioned, advanced, or inserted into the interior recess 114. In another embodiment, the threaded expander 114 does not include a flat head 124; rather, it is simply a threaded cylindrical body including one or more threading features at least at a proximal end thereof. The head 124 can be provided with various types of reception to receive screwdriver, hexnut, alien wrench, or any other shaped tools, if desired, to insert and/or remove the threaded expander 120. To be clear, while the threaded expander is depicted as a bolt or screw, it may take any suitable shape that will cause expansion of the threadform 110 when the expander 120 is inserted into the recess 114.

In the embodiment shown, the threadform 110 includes a longitudinal slot or opening 116 that extends along a portion of the length of the threadform 110. In one embodiment, the slot extends along the entire length of the threadform 110. In another embodiment, the slot 116 is disposed at a proximal end of the threadform 110. In yet a further embodiment, the slot 116 is disposed at a distal end of the threadform 110. The slot 116 may, as discussed herein, facilitate insertion of the threaded expander 120 into the threadform 110, which may help the threadform 110 expand more easily, or expand a larger amount to increase the locking effect of the apparatus described herein.

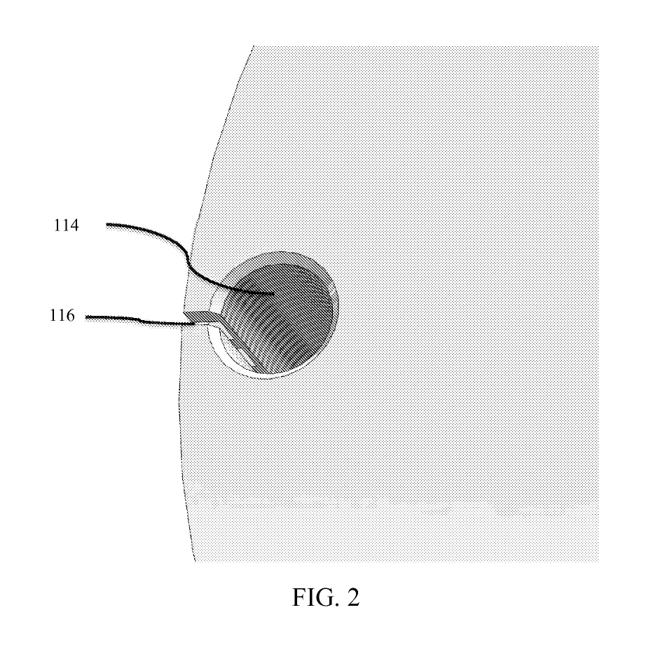

FIG. 2 provides a magnified view of an embodiment of the slot 116 and the interior recess 114. The slot 116 is disposed at a proximal end of the threadform 110. The slot 116 allows for temporary/reversible expansion of the threadform 110 by the threaded expander 120. Although only one slot 116 is shown, it should be understood that more than one slot may be present in the threadform 110. Moreover, multiple interior recesses 114 and corresponding threaded expanders 120 (optionally with corresponding slots 116) may be included, as well, such as disposed in two, three, four, or more positions. These will typically be spaced evenly around the circumference to help distribute the locking forces. The width of the slot 116 is any suitable width to affect expansion of the threaded exterior portion 112. In one embodiment, the width is about 0.1 to 6 inches, preferably about 0.5 to 4 inches, and more preferably about 1 to 3 inches. Of course, the width of the slot will correspond to the overall size of the threadform, and will be sufficiently small to prevent a threaded expander 120 from escaping through the slot once inserted in the interior recess 114.

The locking device 100 in one embodiment, may be used to form an axially locked, multi-component article. The article includes a first component and a second component, with the locking device 100 arranged at an axial end of the first component and extended therethrough to connect to the second component for retaining the first and second components in engagement. In one embodiment, the locking device 100 is integrally formed as part of the first component. In some embodiments, the first component, second component, or both are oilfield equipment, such as tubulars, portions of a top drive, portions of a quill, portions of a rotary handling device, or any combination thereof. It should be understood, however, that the locking device 100 is not limited to oil rig applications. The locking device 100 may be used to lock threaded connections in any equipment, typically that which is exposed to heat/cold cycles, vibrational forces, or both when in use or between uses.

A method of locking two components into retained engagement using the locking device 100 will now be described. The radially expandable threaded exterior portion 112 of the threadform 110 is first engaged with each of the two components. For example, the first and second components may be threaded onto the threaded exterior portion 112. Next, the threaded expander 120 is axially inserted into the interior recess 114 to radially expand the threaded exterior portion 112 so as to lock the two components into retained engagement with each other. In an embodiment, the threaded expander 120 is threaded into interior recess 114 to lock the threaded expander 120 in place and inhibit or prevent it from becoming loosened or completely uncoupling during mechanical vibration or thermal contraction or expansion cycling.

Unlocking the threadform 110 is simple and reliable, as threaded expander 120 is simply untightened. This loosens threaded expander 120, which can be retightened or removed from the interior recess 114, either of which in turn causes the threadform 110 to contract in circumference and radius to loosen the coupled articles. The articles can then be shifted, separated, etc.

The threaded expander 120 can be as long or large in diameter as desired for various applications, and can be easily locked at any selected depth in the interior recess 114 by simply tightening the threaded expander 120. The selected depth can be easily readjusted at any time by simply loosening the threaded expander 120 and re-tightening. Accordingly, the present disclosure provides a readily disengageable, but anti-vibrational threadform locking device that provides a controlled mechanical locking, despite thermal expansion and contraction, loading and unloading, and vibrational forces.

The present disclosure relates to a locking device that includes a non-resilient locking threadform and a threaded expander. The threadform includes a threaded exterior portion that has a length and is configured to connect and retain two adjacent external articles in an axial direction. The threadform has an unexpanded state and an expanded state, and an axially-oriented, threaded interior recess at a proximal end of the threadform. The threaded expander includes a threaded exterior and is oversized relative to the threaded interior recess so as to expand the threaded exterior portion radially from the unexpanded state to the expanded state when the threaded expander is positioned in the threaded interior recess.

The present disclosure further relates to a locking device that includes a non-resilient locking threadform having a threaded exterior portion having a length and a threaded expander, wherein the threaded exterior portion has a longitudinal slot that extends along a portion of the length. The threaded exterior portion is configured to connect and retain two adjacent external articles in an axial direction, and has an unexpanded state and an expanded state. The threaded exterior portion also includes an axially-oriented, threaded interior recess at a proximal end of the threadform. The threaded expander includes a threaded exterior and is oversized relative to the interior recess so as to expand the threaded exterior portion radially from the unexpanded state to the expanded state as the threaded expander is positioned in the threaded interior recess.

Moreover, the present disclosure relates to a method of locking two components into retained engagement from an end of one of the components. The method includes engaging a radially expandable threaded exterior portion of a non-resilient locking threadform with each of the two components so as to be in threaded engagement therewith, and axially inserting a threaded expander having a diameter into a recess at an end of the non-resilient locking threadform having a smaller diameter to radially expand the threaded exterior portion so as to lock the two components into retained engagement to each other.

The term “about,” as used herein, should generally be understood to refer to both numbers in a range of numerals. Moreover, all numerical ranges herein should be understood to include each whole integer within the range.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

Moreover, it is the express intention of the applicant not to invoke 35 U.S.C. §112, paragraph 6 for any limitations of any of the claims herein, except for those in which the claim expressly uses the word “means” together with an associated function.

What is claimed is:

1. A locking device, comprising:
a non-resilient locking threadform that comprises a threaded exterior portion having a length, being configured to connect and retain two adjacent external articles in an axial direction, and having an unexpanded state and an expanded state, and an axially-oriented, threaded interior recess at a proximal end of the threadform; and
a threaded expander having a threaded exterior and being oversized relative to the threaded interior recess so as to expand the threaded exterior portion radially from the unexpanded state to the expanded state as the threaded expander is positioned in the threaded interior recess.

2. The locking device of claim 1, wherein transition to the expanded state increases linearly with a distance of the threaded expander into the threaded interior recess.

3. The locking device of claim 1, wherein the non-resilient locking threadform predominantly comprises a metal.

4. The locking device of claim 3, wherein the non-resilient locking threadform at least substantially comprises a metal.

5. The locking device of claim 1, wherein the threaded interior recess comprises threads with a radius or diameter that is less than the threads of the threaded expander.

6. The locking device of claim 5, wherein the threads of the threaded expander with a radius or diameter that is less than the threads of the threaded expander are located distally from an end of the threaded interior recess.

7. The locking device of claim 1, wherein the threaded expander has a length that is at least substantially the same as a length of the threaded interior recess.

8. An axially locked, multi-component article comprising:
a first component;
a second component; and
the locking device of claim 1 arranged at an axial end of the first component and extended therethrough to connect to the second component and retain the first and second components in engagement.

9. The axially locked, multi-component article of claim 8, wherein the threaded expander is disposed sufficiently far into the threaded interior recess of the non-resilient locking threadform that it does not extend past the proximal end thereof.

10. The axially locked, multi-component article of claim 8, wherein the locking device is integrally formed as part of the first component.

11. The axially locked, multi-component article of claim 8, wherein the first component and/or the second component comprise oilfield equipment.

12. A locking device, comprising:
a non-resilient locking threadform that comprises a threaded exterior portion having a length, being configured to connect and retain two adjacent external articles in an axial direction, and having an unexpanded state and an expanded state, and an axially-oriented, threaded interior recess at a proximal end of the threadform,
wherein the threaded exterior portion has a longitudinal slot that extends along a portion of the length; and
a threaded expander having a threaded exterior and being oversized relative to the interior recess so as to expand the threaded exterior portion radially from the unexpanded state to the expanded state as the threaded expander is positioned in the threaded interior recess.

13. The locking device of claim 12, wherein the non-resilient locking threadform predominantly comprises a metal.

14. The locking device of claim 12, wherein the threaded interior recess comprises threads with a radius or diameter that is less than the threads of the threaded expander.

15. The locking device of claim 12, wherein the slot extends down the entire length of the non-resilient locking threadform.

16. The locking device of claim 12, wherein the slot is disposed at a proximal end of the non-resilient threadform and extends along a length of the threaded interior recess.

17. A method of locking two components into retained engagement from an end of one of the components, which comprises:
engaging a radially expandable threaded exterior portion of a non-resilient locking threadform with each of the two components so as to be in threaded engagement therewith; and
axially inserting a threaded expander having a diameter into a recess at an end of the non-resilient locking threadform having a smaller diameter to radially expand the threaded exterior portion so as to lock the two components into retained engagement to each other.

18. The method of claim 17, wherein the threaded exterior portion is selected to at least predominantly comprise metal.

19. The method of claim 17, wherein the recess comprises threads with a radius or diameter that is less than a plurality of opposing threads disposed on an exterior surface of the threaded expander.

20. The method of claim 17, wherein the threaded exterior portion is selected to comprise a slot extending along an entire length thereof.

21. The method of claim 20, wherein the slot is disposed at a proximal end of the threaded exterior portion.

22. The method of claim 17, wherein the threaded expander is entirely inserted into the recess.

23. The method of claim 17, which further comprises threading the threaded expander into the recess.
